(19) United States
(12) Patent Application Publication
(10) Pub. No.: US 2012/0216515 A1
(43) Pub. Date: Aug. 30, 2012

(54) DEVICE, METHOD, AND SYSTEM FOR EXHAUST GAS TREATMENT

(75) Inventors: Daniel George Norton, Schenectady, NY (US); Dan Hancu, Clifton Park, NY (US); Benjamin Hale Winkler, Albany, NY (US)

(73) Assignee: GENERAL ELECTRIC COMPANY, Schenectady, NY (US)

(21) Appl. No.: 13/034,505

(22) Filed: Feb. 24, 2011

(51) Int. Cl. F01N 3/10; B01D 53/94; B01D 50/00

(52) U.S. Cl. 60/299; 422/171; 423/213.2

(57) ABSTRACT

Various methods and systems are provided for an exhaust gas treatment device for an exhaust gas treatment system. In one example, the exhaust gas treatment device includes a primary flow passage through which exhaust gas flows to the exhaust gas treatment device, a first sub-catalyst partially disposed in the primary flow passage splitting the exhaust gas into a first gas flow and a bypass flow, and a second sub-catalyst disposed downstream of the first sub-catalyst in the bypass flow forming a second gas flow, where the second gas flow is different from the first gas flow.

### FIELD

The subject matter disclosed herein relates to exhaust gas systems for an engine, and other embodiments relate to devices and methods for controlling an exhaust gas flow.

### BACKGROUND

During operation, internal combustion engines generate various combustion by-products that are emitted from the engine in an exhaust stream. As such, an exhaust gas treatment system is included in an exhaust system of the engine in order to reduce regulated emissions, for example. In some examples, the exhaust gas treatment system includes a flow-through device, such as a catalyst, through which the exhaust stream flows. In such an example, a pressure drop may be induced on the system dependent on parameters such as the flow rate, density, and viscosity of the exhaust stream, and the geometry of the flow-through device. The pressure drop may result in parasitic losses, for example, thereby reducing the efficiency of the engine.

### BRIEF DESCRIPTION

In one embodiment, an exhaust gas treatment device for an exhaust gas treatment system includes a primary flow passage through which exhaust gas flows to the exhaust gas treatment device. The exhaust gas treatment device further includes a first sub-catalyst partially disposed in the primary flow passage splitting the exhaust gas into a first gas flow and a bypass flow, and a second sub-catalyst disposed downstream of the first sub-catalyst in the bypass flow forming a second gas flow, where the second gas flow is different from the first gas flow.

By including at least two sub-catalysts in the exhaust gas treatment device, each sub-catalyst with a separate flow path, a cross-sectional area through which the exhaust gas flows may be increased. Further, when a cross-sectional area of the catalysts is increased, a length of the catalyst can be decreased without reducing the efficiency of the exhaust gas treatment device. In this manner, a pressure drop on the system may be reduced, for example, as the drop in pressure decreases with a decrease in length.

It should be understood that the brief description above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The present invention will be better understood from reading the following description of non-limiting embodiments, with reference to the attached drawings, wherein below:

FIG. 1 shows a schematic diagram of an example embodiment of a rail vehicle with an exhaust gas treatment system according to an embodiment of the invention.

FIG. 2 shows a perspective view, approximately to scale, of an engine with a turbocharger and an exhaust gas treatment system.

FIG. 3 shows a perspective view, approximately to scale, of an example embodiment of an engine cab.

FIG. 4 shows a schematic diagram of a prior art exhaust gas treatment device with a single sub-catalyst.

FIGS. 5-10 show schematic diagrams of example embodiments of exhaust gas treatment devices with a plurality of sub-catalysts.

FIG. 11 shows a flow chart illustrating an example control method for an exhaust gas treatment system.

### DETAILED DESCRIPTION

The following description relates to various embodiments of an exhaust gas treatment device which includes a plurality of sub-catalysts which form separate flow paths through the exhaust gas treatment device. In some embodiments, the exhaust gas treatment device includes a primary flow passage through which exhaust gas flows to the exhaust gas treatment device. The exhaust gas treatment device further includes a first sub-catalyst partially disposed in the primary flow passage splitting the exhaust gas into a first gas flow and a bypass flow, and a second sub-catalyst disposed in the bypass flow forming a second gas flow, where the second gas flow is different from the first gas flow. In other embodiments, the exhaust gas treatment device includes more than two sub-catalysts disposed therein.

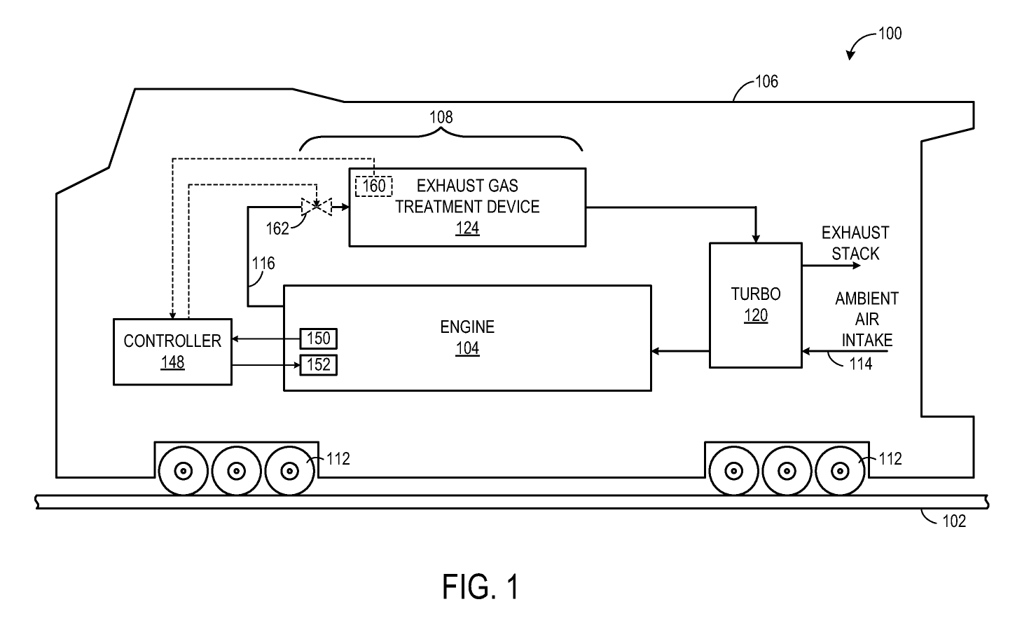

In some embodiments, the exhaust gas treatment device is configured for an exhaust gas treatment system in a vehicle, such as a rail vehicle. For example, FIG. 1 shows a block diagram of an example embodiment of a vehicle system 100 (e.g., a locomotive system), herein depicted as a rail vehicle 106, configured to run on a rail 102 via a plurality of wheels 112. As depicted, the rail vehicle 106 includes an exhaust gas treatment system 108 coupled to an engine 104. In other non-limiting embodiments, engine 104 may be a stationary engine, such as in a power-plant application, or an engine in a ship propulsion system or an off-highway vehicle system.

The engine 104 receives intake air for combustion from an intake conduit 114. The intake conduit 114 receives ambient air from an air filter (not shown) that filters air from outside of the rail vehicle 106. Exhaust gas resulting from combustion in the engine 104 is supplied to an exhaust passage 116. Exhaust gas flows through the exhaust passage 116, and out of an exhaust stack of the rail vehicle 106. In one example, the engine 104 is a diesel engine that combusts air and diesel fuel through compression ignition. In other non-limiting embodiments, the engine 104 may combust fuel including gasoline, kerosene, biodiesel, or other petroleum distillates of similar density through compression ignition (and/or spark ignition).

The vehicle system 100 includes a turbocharger 120 that is arranged between the intake conduit 114 and the exhaust passage 116. The turbocharger 120 increases air charge of ambient air drawn into the intake conduit 114 in order to provide greater charge density during combustion to increase power output and/or engine-operating efficiency. The turbocharger 120 may include a compressor (not shown in FIG. 1) which is at least partially driven by a turbine (not shown in FIG. 1). While in this case a single turbocharger is included, the system may include multiple turbine and/or compressor stages.

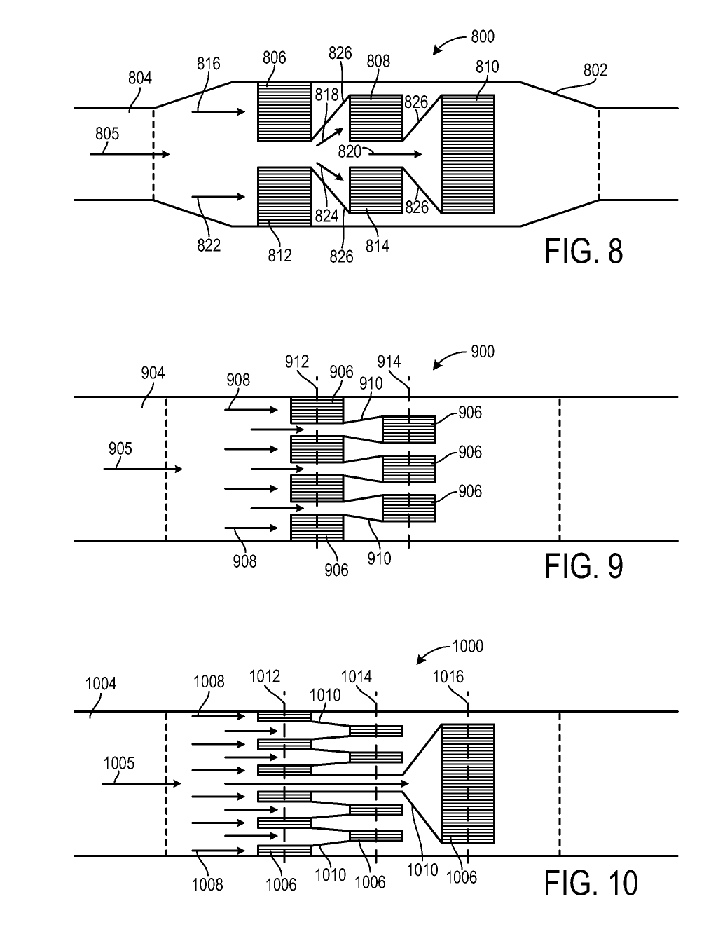

The vehicle system 100 further includes an exhaust gas treatment system 108 coupled in the exhaust passage downstream of the turbocharger 120. The exhaust gas treatment system 108 includes an exhaust gas treatment device 124. The exhaust gas treatment device may be a catalyst, for example, such as a diesel oxidation catalyst (DOC), a diesel particulate filter (DPF), a selective catalytic reduction (SCR) catalyst, etc. As further elaborated with reference to FIGS. 5-10, the exhaust gas treatment device 124 may include a plurality of sub-catalysts disposed therein which divide a primary flow passage into a number of flow paths corresponding to the number of sub-catalysts.

The rail vehicle 106 further includes a controller 148 to control various components related to the vehicle system 100. In one example, the controller 148 includes a computer control system. The controller 148 further includes computer readable storage media (not shown) including code for enabling on-board monitoring and control of rail vehicle operation. The controller 148, while overseeing control and management of the vehicle system 100, may be configured to receive signals from a variety of engine sensors 150, as further elaborated herein, in order to determine operating parameters and operating conditions, and correspondingly adjust various engine actuators 152 to control operation of the rail vehicle 106. For example, the controller 148 may receive signals from various engine sensors 150 including, but not limited to, engine speed, engine load, boost pressure, exhaust pressure, ambient pressure, exhaust temperature, etc. Correspondingly, the controller 148 may control the vehicle system 100 by sending commands to various components such as traction motors, alternator, cylinder valves, throttle, etc.

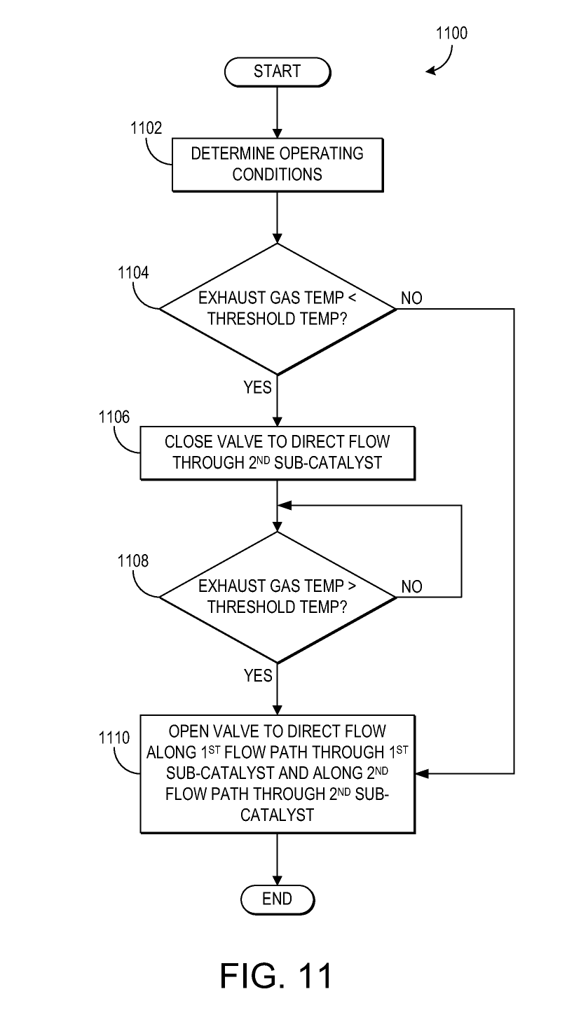

As further elaborated with reference to FIG. 11, in some embodiments, the controller 148 may receive communication from one or more temperature sensors 160 positioned in the exhaust gas treatment system 108. In response to communication from the temperature sensors 160, the controller 148 may send a signal to an actuator to control the position of a valve 162, for example. Valve 162 may be a gate valve, for example, which extends partially across the exhaust passage 116 to substantially reduce the flow of exhaust gas to one or more sub-catalysts within the exhaust gas treatment device 124. In other examples, valve 162 may be another type of valve which reduces exhaust gas flow to one or more of the sub-catalysts while not completely restricting flow to the exhaust gas treatment device 124.

In one example embodiment, the vehicle system is a locomotive system which includes an engine cab defined by a roof assembly and side walls. The locomotive system further comprises an engine positioned in the engine cab such that a longitudinal axis of the engine is aligned in parallel with a length of the cab. Further, an exhaust gas treatment system is included, and is mounted on the engine within a space defined by a top surface of an exhaust manifold of the engine, the roof assembly, and the side walls of the engine cab such that a longitudinal axis of the exhaust gas treatment system is aligned in parallel with the longitudinal axis of the engine. The exhaust gas treatment system includes an exhaust gas treatment device with a primary flow passage and a plurality of sub-catalysts. Each of the sub-catalysts forms a corresponding flow path configured to receive a different portion of an exhaust gas flow from the exhaust manifold of the engine. Detailed examples of such an embodiment are described below.

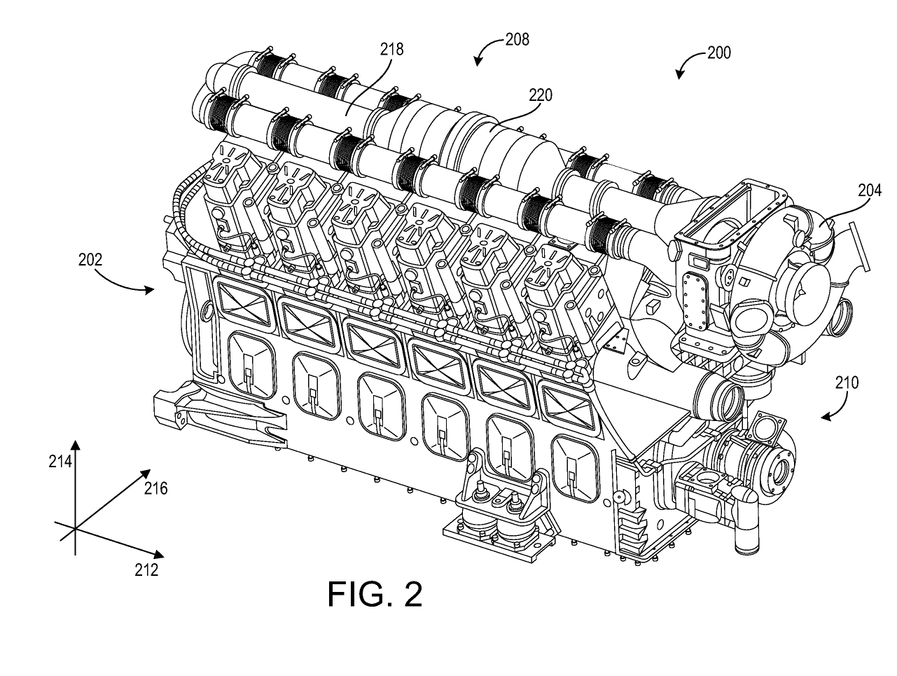

Turning to FIG. 2, an example engine system 200 is illustrated, the engine system 200 including an engine 202, such as the engine 104 described above with reference to FIG. 1. FIG. 2 is approximately to-scale. The engine system further including a turbocharger 204 mounted on a front side of the engine and an exhaust gas treatment system 208 positioned on a top portion of the engine.

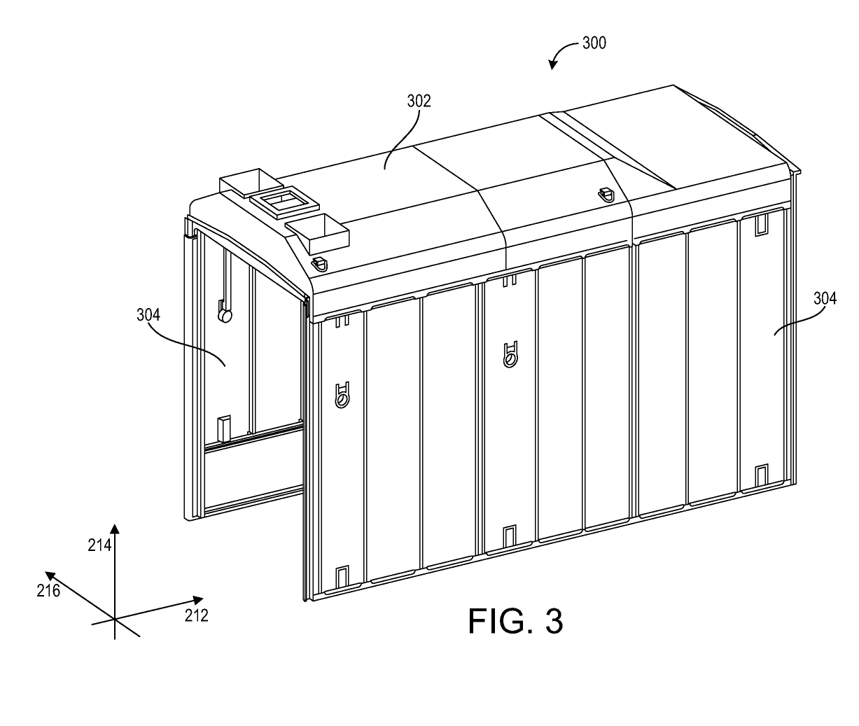

In the example of FIG. 2, engine 202 is a V-engine which includes two banks of cylinders that are positioned at an angle of less than 180 degrees with respect to one another such that they have a V-shaped inboard region and appear as a V when viewed along a longitudinal axis of the engine. The longitudinal axis of the engine is defined by its longest dimension in this example. In the example of FIG. 2, and in FIG. 3, the longitudinal direction is indicated by 212, the vertical direction is indicated by 214, and the lateral direction is indicated by 216. Each bank of cylinders includes a plurality of cylinders. Each of the plurality of cylinders includes an intake valve which is controlled by a camshaft to allow a flow of compressed intake air to enter the cylinder for combustion. Each of the cylinders further includes an exhaust valve which is controlled by the camshaft to allow a flow of combusted gases (e.g., exhaust gas) to exit the cylinder.

In the example embodiment of FIG. 2, the exhaust gas exits the cylinder and enters an exhaust manifold positioned within the V (e.g., in an inboard orientation). In other embodiments, the exhaust manifold may be in an outboard orientation, for example, in which the exhaust manifold is positioned outside of the V. In the example of FIG. 2, the engine 202 is a V-12 engine. In other examples, the engine may be a V-6, I-4, I-6, I-8, opposed 4, or another engine type.

As mentioned above, the engine system 200 includes a turbocharger 204 positioned at a front end 210 of the engine 202. In the example of FIG. 2, the front end 210 of the engine is facing toward a right side of the page. Intake air flows through the turbocharger 204 where it is compressed by a compressor of the turbocharger before entering the cylinders of the engine 202. In some examples, the engine further includes a charge air cooler which cools the compressed intake air before it enters the cylinder of the engine 202. The turbocharger is coupled to the exhaust manifold of the engine 202 such that exhaust gas exits the cylinders of the engine 202 and then flows through an exhaust passage 218 and enters an exhaust gas treatment system 208 before entering a turbine of the turbocharger 204.

In the example embodiment shown in FIG. 2, the exhaust gas treatment system 208 is positioned vertically above the engine 202. The exhaust gas treatment system 208 is positioned on top of the engine 202 such that it fits within a space defined by a top surface of an exhaust manifold of the engine 202, a roof assembly 302 of an engine cab 300, and the side walls 304 of the engine cab. The engine cab 300 is illustrated in FIG. 3. The engine 202 may be positioned in the engine cab 300 such that the longitudinal axis of the engine is aligned in parallel with a length of the cab 300. As depicted in FIG. 2, a longitudinal axis of the exhaust gas treatment system is aligned in parallel with the longitudinal axis of the engine.

The exhaust gas treatment system 208 is defined by the exhaust passage aligned in parallel with the longitudinal axis of the engine. In the example embodiment shown in FIG. 2, the exhaust gas treatment system 208 includes an exhaust gas treatment device 220, such as a catalyst. In some embodiments, the exhaust gas treatment device 220 includes a plurality of sub-catalysts, as will be described in greater detail below with reference to FIGS. 5-10. In other non-limiting embodiments, the exhaust gas treatment system 208 includes more than one exhaust gas treatment device, such as a diesel oxidation catalyst (DOC), a diesel particulate filter (DPF) coupled downstream of the DOC, and a selective catalytic reduction (SCR) catalyst coupled downstream of the diesel particulate filter. In another example embodiment, the exhaust gas treatment system includes an SCR system for reducing NO species generated in the engine exhaust stream and a particulate matter (PM) reduction system for reducing an amount of particulate matter, or soot, generated in the engine exhaust stream. The various exhaust after-treatment components included in the SCR system may include an SCR catalyst, an ammonia slip catalyst (ASC), and a structure (or region) for mixing and hydrolyzing an appropriate reductant used with the SCR catalyst, for example. The structure or region may receive the reductant from a reductant storage tank and injection system, for example.

Further, the exhaust flow passage 218 includes an inlet through which the exhaust gas stream enters the exhaust gas treatment system 208.

In another embodiment, the exhaust gas treatment system 208 may include a plurality of distinct flow passages aligned in a common direction (e.g., along the longitudinal axis of the engine). In such an embodiment, each of the plurality of flow passages may include one or more exhaust gas treatment devices which may each include a plurality of sub-catalysts.

By positioning the exhaust gas treatment system on top of the engine such that the exhaust passage is aligned in parallel with the longitudinal axis of the engine, as described above, a compact configuration can be enabled. In this manner, the engine and exhaust gas treatment system can be disposed in a space, such as an engine cab as described above, where the packaging space may be limited.

In a vehicle system, such as the locomotive system described above, in which packaging space is limited, a cross-sectional area of the exhaust gas treatment device perpendicular to the direction of exhaust gas flow may be reduced such that the device fits within the space between the engine and the roof assembly of the engine cab. For example, a diameter of the exhaust gas treatment device is reduced. Further, in such a configuration, the device may be elongated so that exhaust gas is exposed to the catalyst for a desired duration, for example.

In some examples, the catalyst may have a honeycomb-like structure formed of a plurality of channels through which the exhaust gas flows. In such an embodiment, a pressure drop induced by the exhaust gas treatment device may be increased when a length of the device is increased according to the Hagen-Poiseuille equation for pressure drop through a tube (e.g., a channel):

$$Δ {P}_{tube} = \frac{8 μ LQ}{π {r}^{4}} , \qquad ( 1 )$$

where μ is the viscosity of the fluid flowing through the tube, L is the length of the tube, Q is the volumetric flow rate, and r is the radius of the tube. If a pressure drop on the system is increased, parasitic losses on the system may be increased thereby decreasing the efficiency of the engine. As can be further deduced from the Hagen-Poiseuille equation (1), the pressure drop can be reduced by increasing the cross-sectional area and/or decreasing the length of the tube.

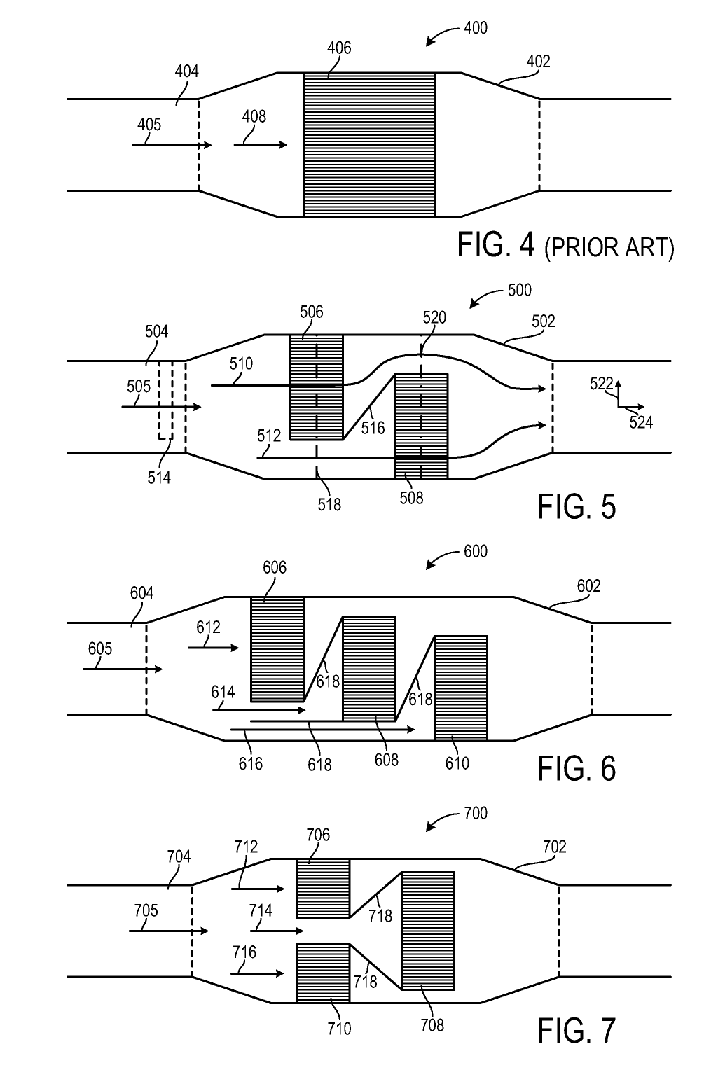

FIG. 4 shows an example embodiment of a typical prior art exhaust gas treatment device 402 in an exhaust gas treatment system 400. As depicted in FIG. 4, exhaust gas 405 from the engine (not shown in FIG. 4) flows along a primary flow passage 404 and into the exhaust gas treatment device 402. For example, the primary flow passage is an entry flow passage. The exhaust gas treatment device 402 includes a single sub-catalyst 406 which extends substantially from one side of the exhaust gas treatment device to an opposite side of the exhaust gas treatment device, substantially filling a cross-section of the exhaust gas treatment device. Because there is a single sub-catalyst 406, once the exhaust gas 405 enters the exhaust gas treatment device 402, the exhaust gas flows along a single flow path 408 through the sub-catalyst 406 and out of the exhaust gas treatment device 402.

When the length of the exhaust gas treatment device 402 is increased, a pressure drop on the system is increased, as described above, which may lead to a decrease in engine efficiency. Thus, FIGS. 5-10 show example embodiments of exhaust gas treatment devices in which the cross-sectional area of the catalyst is increased by dividing the flow of exhaust gas in the exhaust gas treatment device such that a different portion of exhaust gas flows through each of a plurality of sub-catalysts arranged in a tiered configuration in the exhaust gas treatment device. As such, a duration of exhaust exposure to the exhaust gas treatment device may be maintained without adding length to the exhaust gas treatment device. In this way, a pressure drop caused by the flow of exhaust gas through the device may be reduced.

In an example embodiment, an exhaust gas treatment device for an exhaust gas treatment system includes a primary flow passage through which exhaust gas flows to the exhaust gas treatment device. The device further includes a first sub-catalyst partially disposed in the primary flow passage splitting the exhaust gas into a first gas flow and a bypass flow, and a second sub-catalyst disposed downstream of the first sub-catalyst in the bypass flow forming a second gas flow, where the first gas flow is different from the second gas flow.

In another example embodiment, an exhaust gas treatment device includes a flow passage and a first sub-catalyst disposed in the flow passage and located at a first location along the flow passage. The first sub-catalyst partially but not entirely fills a radial extent of the flow passage at the first location. Further, a portion of the radial extent at the first location that is not filled by the first sub-catalyst is unoccupied, such that exhaust gas can flow unfettered around the first sub-catalyst. The exhaust gas treatment device further includes a second sub-catalyst disposed in the flow passage and located at a downstream, second location along the flow passage. The second sub-catalyst partially but not entirely fills a radial extent of the flow passage at the second location. Further, a portion of the radial extent at the second location that is not filled by the second sub-catalyst is unoccupied, such that exhaust gas can flow unfettered around the second sub-catalyst. FIG. 5 shows such an embodiment.

The primary flow passage is an entry flow passage where the exhaust gas flow converges into the exhaust gas treatment device, for example, before the flow is split by the sub-catalysts. As used herein, the term “split” implies the exhaust gas flow is divided into two or more separate portions of gas flow (e.g., first gas flow, bypass flow, and the like). Further, “partially disposed in” implies the sub-catalyst extends partially across the diameter of the exhaust gas treatment device such that at least some exhaust gas can bypass the sub-catalyst. In particular, a portion of a radial extent of the flow passage at a location of the sub-catalyst is unoccupied such that exhaust gas can flow unfettered around the sub-catalyst. The gas flow is the operational flow through the sub-catalyst. For example, the first gas flow is the operational flow through the first sub-catalyst. Further, “bypass” implies the exhaust flow does not flow through the sub-catalyst. For example, the bypass flow does not pass through the first sub-catalyst. Instead, the bypass flow flows around the first sub-catalyst where it becomes the second gas flow upon passing through the second sub-catalyst. In other examples, as described below, the bypass flow may be further divided into two or more gas flows.

The example embodiment depicted in FIG. 5 shows an exhaust gas treatment system 500 that includes an exhaust gas treatment device 502 with a split flow path. An exhaust gas flow 505 from an engine, such as engine 202 described above with reference to FIG. 2, enters the exhaust gas treatment device 502 via a primary flow passage 504 (e.g., an entry flow path). Once inside the exhaust gas treatment device 502, the primary flow passage 504 is divided into two gas flows along two flow paths, as will be described below.

In the example embodiment of FIG. 5, the exhaust gas treatment device 502 includes a first sub-catalyst 506 and a second sub-catalyst 508. As depicted, the first sub-catalyst 506 is disposed at a first location upstream of the second sub-catalyst 508, which is located at a second location, such that the sub-catalysts are arranged in a tiered configuration along the length of the exhaust gas treatment device. Further, each of the sub-catalysts extends only partially across a diameter of the exhaust gas treatment device 502 such that each sub-catalyst receives a different portion of the exhaust gas flow. Specifically, each sub-catalyst partially but not entirely fills a radial extent of the flow passage.

As an example, as shown in FIG. 5, the first sub-catalyst 506 extends from a top of the exhaust gas treatment device 502 to a position approximately three quarters across the diameter of the exhaust gas treatment device 502 at radial extent 518. In the example of FIG. 5, the radial direction is indicated at 522 and the longitudinal direction is indicated at 524. As depicted, a portion of the radial extent 518 that is not filled by the first sub-catalyst 506 is unoccupied, such that exhaust gas can flow unfettered around the first sub-catalyst 506. The second sub-catalyst 508 extends from a bottom of the exhaust gas treatment device 502 to a position approximately three quarters across the diameter of the exhaust gas treatment device 502 at radial extent 520. As depicted a portion of the radial extent 520 is not filled by the second sub-catalyst is unoccupied, such that exhaust gas can flow unfettered around the second sub-catalyst 518. In other embodiments, the sub-catalysts may extend from the sides of the exhaust gas treatment device. In this manner, a surface area of the catalyst through which the exhaust gas flows is increased.

In some embodiments, the first sub-catalyst 506 and the second sub-catalyst 508 are substantially the same. For example, the sub-catalysts may be formed of the same type of material (e.g., substrate, catalyst, washcoat, or the like) and have the same size and structure (e.g., channel diameter and spacing). In other embodiments, the first sub-catalyst 506 and the second sub-catalyst 508 may be different. For example, the sub-catalysts may have different sizes. In one embodiment, the sub-catalysts may have different substrates and/or coatings such that one of the sub-catalysts is more effective at a relatively high temperature and the other sub-catalyst is more effective at a relatively low temperature, for example. In such an embodiment, the exhaust gas treatment system 500 may include a valve 514 that can be closed so that exhaust gas flow to one of the sub-catalysts is substantially reduced, as will be described in greater detail below with reference to FIG. 11.

As shown in the example of FIG. 5, the first sub-catalyst 506 forms a first flow path 510 along which a first portion of gas flow from the primary flow passage 504 flows. A second, different, portion of gas flow bypasses the first sub-catalyst and flows along a second flow path 512 formed by the second sub-catalyst 508. A flow divider 516 interconnects distal edges of the first sub-catalyst 506 and the second sub-catalyst 508 that are not abutting the flow passage such that exhaust gas that exits sub-catalyst 506 does not enter sub-catalyst 508. As depicted in FIG. 5, the flow divider 516 channels exhaust passing through the unoccupied radial extent 518 at the location of the first sub-catalyst 506 to an input of the second sub-catalyst 508. The flow divider 516 further channels exhaust exiting the first sub-catalyst 506 to the unoccupied radial extent 520 at the location of the second sub-catalyst 508. The divider 516 may be formed of any suitable material such as stainless steel, for example. In some embodiments, one or both sides of the divider 516 may be coated with a catalytic material to further facilitate reduced emissions. The divider 516 may be attached or otherwise secured in any suitable manner.

Thus, an exhaust gas treatment device may include two sub-catalysts which divide the exhaust flow through the exhaust gas treatment device into two flow paths. In this way, a catalyst surface area through which exhaust gas flows may be increased and a length along which each portion of exhaust gas flow may be decreased, thereby reducing a pressure drop on the system.

FIG. 6 shows another example embodiment of an exhaust gas treatment system 600 with an exhaust gas treatment device 602 with a divided flow path. An exhaust gas flow 605 from an engine, such as engine 202 described above with reference to FIG. 2, enters the exhaust gas treatment device 602 via primary flow passage 604 (e.g., entry flow path). Once inside the exhaust gas treatment device 602, the primary flow passage 604 is divided into three gas flows along three flow paths, as will be described below.

As shown in FIG. 6, exhaust gas treatment device 602 includes a first sub-catalyst 606, a second sub-catalyst 608, and a third sub-catalyst 610 arranged in a tiered configuration along a length of the exhaust gas treatment device 602. Sub-catalyst 608 is positioned downstream of sub-catalyst 606 and upstream of sub-catalyst 610. Further, each of the sub-catalysts extends only partially across a diameter of the exhaust gas treatment device 602 such that each sub-catalyst receives a different portion of the exhaust gas flow 605.

In some embodiments, the first sub-catalyst 606, the second sub-catalyst 608, and the third sub-catalyst 610 are substantially the same. For example, the sub-catalysts may be formed of the same material (e.g., substrate, catalyst, washcoat, or the like) and have the same size and structure (e.g., channel diameter and spacing). In other embodiments, each of the sub-catalysts may be different. In one example, each of the sub-catalysts may have a different shape and cross-sectional area. Alternatively or additionally, the sub-catalysts may have different substrates and/or coatings such that at least one of the sub-catalysts is more effective at a relatively high temperature and the other sub-catalysts are more effective at a relatively low temperature, for example. In still other embodiments, two of the sub-catalysts may be the same while the other sub-catalyst is different.

As is further illustrated in the example of FIG. 6, the first sub-catalyst 606 forms a first flow path 612 along which a first portion of exhaust gas from the primary flow passage 604 flows. A second, different, portion of gas flow bypasses the first sub-catalyst 606 and flows along a second flow path 614 formed by the second sub-catalyst 608. A third portion of gas flow, which is different from the first and second portions of gas flow, bypassed the first and second sub-catalysts 606 and 608 and flows along a third flow path 616 through the third sub-catalyst 610. The exhaust gas treatment device 602 further includes a plurality of flow dividers 618. For example, one divider 618 is coupled between the first sub-catalyst 606 and the second sub-catalyst 608 such that exhaust gas that exits sub-catalyst 606 does not enter sub-catalyst 608. Another divider 618 is coupled between the second sub-catalyst 608 and the third sub-catalyst 610 such that exhaust gas that exits sub-catalyst 608 does not enter sub-catalyst 610.

The example embodiment depicted in FIG. 6 further includes a third divider coupled to the second sub-catalyst 608 in order to divide the entry flow path into the second flow path 614 and the third flow path 616 upstream of the second and third sub-catalysts 608 and 610, for example. In other embodiments, the exhaust gas treatment device may not include the third divider. The dividers 618 may be formed of any suitable material such as stainless steel, for example. In some embodiments, one or both sides of one or more of the dividers 618 may be coated with a catalytic material to further facilitate emissions reduction. The dividers 618 may be attached or otherwise secured in any suitable manner.

Thus, an exhaust gas treatment device may include three sub-catalysts which divide the exhaust flow through the exhaust gas treatment device into three flow paths. In this way, a catalyst surface area through which exhaust gas flows may be increased and a length along which each portion of exhaust gas flow may be decreased, thereby reducing a pressure drop on the system

FIG. 7 shows another example embodiment of an exhaust gas treatment system 700 with an exhaust gas treatment device 702 with a divided flow path. An exhaust gas flow 705 from an engine, such as engine 202 described above with reference to FIG. 2, enters the exhaust gas treatment device 702 via primary flow passage 704 (e.g., entry flow path). Once inside the exhaust gas treatment device 702, the primary flow passage 704 is divided into two or three gas flows along a corresponding number of flow paths, as will be described below.

In the example embodiment of FIG. 7, the exhaust gas treatment device 702 includes a first sub-catalyst 706, a second sub-catalyst 708, and a third sub-catalyst 710 arranged in a tiered configuration along a length of the exhaust gas treatment device 702. Sub-catalyst 708 is disposed downstream of sub-catalysts 706 and sub-catalyst 710. Further, each of the sub-catalysts extends only partially across a diameter of the exhaust gas treatment device 602 such that each sub-catalyst receives a different portion of the exhaust gas flow 705.

In some embodiments, the first sub-catalyst 706, the second sub-catalyst 708, and the third sub-catalyst 710 are substantially the same. For example, the sub-catalysts may be formed of the same material (e.g., substrate, catalyst, washcoat, or the like) and have the same size and structure (e.g., channel diameter and spacing). In other embodiments, each of the sub-catalysts may be different. In one example, one or more of the sub-catalysts may have a different shape and/or cross-sectional area, as shown in FIG. 7. Alternatively or additionally, the sub-catalysts may have different substrates and/or coatings such that one or more of the sub-catalysts are more effective at a relatively high temperature and the other sub-catalysts are more effective at a relatively low temperature, for example. In still other embodiments, two of the sub-catalysts may be the same while the other sub-catalyst is different.

As is further shown in the example of FIG. 7, the first sub-catalyst 706 forms a first flow path 712 along which a first portion of exhaust gas from the primary flow passage 704 flows. A second, different portion of gas flow bypasses the first sub-catalyst 706 and flows along a second flow path 714 formed by the second sub-catalyst 708. A third portion of gas flow, which is different from the first and second portions of exhaust gas, bypasses the first and second sub-catalysts 706 and 708 and flows along a third flow path 716 through the third sub-catalyst 710. The exhaust gas treatment device 702 further includes a plurality of dividers 718. For example, one divider 718 is coupled between the first sub-catalyst 706 and the second sub-catalyst 708 such that exhaust gas that exits sub-catalyst 706 does not enter sub-catalyst 708. Another divider 718 is coupled between the second sub-catalyst 708 and the third sub-catalyst 710 such that exhaust gas that exits sub-catalyst 710 does not enter sub-catalyst 708. The dividers 718 may be formed of any suitable material such as stainless steel, for example. In some embodiments, one or both sides of one or more of the dividers 718 may be coated with a catalytic material to further facilitate emissions reduction. The dividers 718 may be attached or otherwise secured in any suitable manner.

In some examples, the first sub-catalyst 706 and the third sub-catalyst 710 may be the same sub-catalyst which form a first flow path (e.g., flow paths 712 and 716 are part of the same flow path). For example, the sub-catalyst may have a ring-shape which appears as two sub-catalysts when viewed through a cross-section, such as in FIG. 7. In such an example, the exhaust gas treatment device 702 includes two sub-catalysts which split the exhaust gas flow 705 into two flow paths along which two different portions of exhaust gas flow.

Thus, an exhaust gas treatment device may include two or three sub-catalysts which divide the exhaust flow through the exhaust gas treatment device into two or three flow paths, respectively. In this way, a catalyst surface area through which exhaust gas flows may be increased and a length along which each portion of exhaust gas flow may be decreased, thereby reducing a pressure drop on the system

Another example embodiment of an exhaust gas treatment system 800 with an exhaust gas treatment device 802 with a divided flow path is shown in FIG. 8. An exhaust gas flow 805 from an engine, such as engine 202 described above with reference to FIG. 2, enters the exhaust gas treatment device 802 via primary flow passage 804 (e.g., entry flow path). Once inside the exhaust gas treatment device 802, the primary flow passage 804 is divided into three, four, or five gas flows along a corresponding number of flow paths, as will be described below.

In the example embodiment of FIG. 8, the exhaust gas treatment device 802 includes a first sub-catalyst 806, a second sub-catalyst 808, a third sub-catalyst 810, a fourth sub-catalyst 812, and a fifth sub-catalyst 814 arranged in a tiered configuration along a length of the exhaust gas treatment device 802. Sub-catalysts 808 and 814 are positioned downstream of sub-catalysts 806 and 812 and upstream of sub-catalysts 810. Further, each of the sub-catalysts extends only partially across a diameter of the exhaust gas treatment device 802 such that each sub-catalyst receives a different portion of the exhaust gas flow 805.

In some embodiments, the first sub-catalyst 806, the second sub-catalyst 808, the third sub-catalyst 810, the fourth sub-catalyst 812, and the fifth sub-catalyst 814 are substantially the same. For example, the sub-catalysts may be formed of the same material (e.g., substrate, catalyst, washcoat, or the like) and have the same size and structure (e.g., channel diameter and spacing). In other embodiments, each of the sub-catalysts may be different. In one example, one or more of the sub-catalysts may have a different shape and/or cross-sectional area, as shown in FIG. 8. Alternatively or additionally, the sub-catalysts may have different substrates and/or coatings such that one or more of the sub-catalysts are more effective at a relatively high temperature and the other sub-catalysts are more effective at a relatively low temperature, for example.

As is further shown in the example of FIG. 8, the first sub-catalyst 806 forms a first flow path 816 along which a first portion of gas flow from the primary flow passage 804 flows. A second, different, portion of gas flow flows along a second flow path 818 formed by the second sub-catalyst 808. A third portion of gas flow, which is different from the first and second portions of gas flow, flows along a third flow path 820 through the third sub-catalyst 810. A fourth portion of exhaust gas, which is different from the first, second, and third portions of exhaust gas, flows along a fourth flow path 822 through the fourth sub-catalyst 812. Finally, a fifth portion of exhaust gas, which is different from the first, second, third, and fourth portions of exhaust gas, flows along a fifth flow path 824 through the fifth sub-catalyst 814.

The exhaust gas treatment device 802 further includes a plurality of flow dividers 826. For example, one divider 826 is coupled between the first sub-catalyst 806 and the second sub-catalyst 808 such that exhaust gas that exits sub-catalyst 806 does not enter any of the other sub-catalysts. Another divider 826 is coupled between the second sub-catalyst 808 and the third sub-catalyst 810 such that exhaust gas that exits sub-catalyst 808 does not enter sub-catalyst 810. Another divider 826 is coupled between the fourth sub-catalyst 812 and the fifth sub-catalyst 814 such at that exhaust gas that exits sub-catalyst 812 foes not enter the other sub-catalysts. Another divider 826 is coupled between the fifth sub-catalyst 814 and the third sub-catalyst 810 such that exhaust gas that exits sub-catalyst 814 does not enter the third sub-catalyst 810. The dividers 826 may be formed of any suitable material such as stainless steel, for example. In some embodiments, one or both sides of one or more of the dividers 826 may be coated with a catalytic material to further facilitate emissions reduction. The dividers 826 may be attached or otherwise secured in any suitable manner.

In some examples, the first sub-catalyst 806 and the fourth sub-catalyst 812 may be the same sub-catalyst which form a first flow path (e.g., flow paths 816 and 822 are part of the same flow path). For example, the sub-catalyst may have a ring-shape which appears as two sub-catalysts when viewed through a cross-section, such as in FIG. 8. In such an example, the exhaust gas treatment device 802 includes four sub-catalysts which form two flow paths along which two different portions of exhaust gas flow.

Similarly, the second sub-catalyst 808 and the fifth sub-catalyst 814 may be the same ring-shaped sub-catalyst which forms a second flow path (e.g., flow path 818 and 824 are part of the same flow path). In this manner, the exhaust gas treatment device 802 may include two ring-shaped sub-catalysts forming two separate flow paths, and a third cylindrical sub-catalyst forming a third flow path which is different from the other two flow paths.

Thus, an exhaust gas treatment device may include three, four, or five sub-catalysts which divide the exhaust flow through the exhaust gas treatment device into three, four, or five flow paths, respectively. In this way, a catalyst surface area through which exhaust gas flows may be increased and a length along which each portion of exhaust gas flow may be decreased, thereby reducing a pressure drop on the system

FIG. 9 shows another example embodiment of an exhaust gas treatment system 900 with an exhaust gas treatment device 902 with a divided flow path. An exhaust gas flow 905 from an engine, such as engine 202 described above with reference to FIG. 2, enters the exhaust gas treatment device 902 via primary flow passage 904 (e.g., entry flow path). Once inside the exhaust gas treatment device 902, the primary flow passage 904 is divided into four, five, six, or seven gas flows along a corresponding number of flow paths, as will be described below.

In the example embodiment of FIG. 9, the exhaust gas treatment device 902 includes seven sub-catalysts 906 disposed therein and arranged in a tiered configuration along a length of the exhaust gas treatment device 902. Four of the sub-catalysts are positioned along the same line 912 and the other three sub-catalysts are positioned downstream along another line 914. Each of the sub-catalysts 906 extends only partially across a diameter of the exhaust gas treatment device 902 such that each sub-catalyst receives a different portion of the exhaust gas flow 905. In one example embodiment, each of the sub-catalysts 906 is a different exhaust gas treatment device, for example.

In some embodiments, each of the sub-catalysts 906 is substantially the same. For example, the sub-catalysts 906 may be formed of the same material (e.g., substrate, catalyst, washcoat, or the like) and have the same size and structure (e.g., channel diameter and spacing), such as shown in FIG. 9. In other embodiments, each of the sub-catalysts may be different. In one example, one or more of the sub-catalysts may have a different shape and/or cross-sectional area. Alternatively or additionally, the sub-catalysts may have different substrates and/or coatings such that one of the sub-catalysts is more effective at a relatively high temperature and the other sub-catalyst is more effective at a relatively low temperature, for example.

As is further shown in the example of FIG. 9, each of the sub-catalysts 906 forms a flow path 908 along which a different portion of exhaust gas 905 from the primary flow passage 904 flows. The exhaust gas treatment device 902 further includes a plurality of dividers 910 positioned between the sub-catalysts such that exhaust gas that exits one sub-catalyst does not enter any of the other sub-catalysts. The dividers 910 may be formed of any suitable material such as stainless steel, for example. In some embodiments, one or both sides of one or more of the dividers 910 may be coated with a catalytic material to further facilitate emissions reduction. The dividers 910 may be attached or otherwise secured in any suitable manner.

In some examples, two of the sub-catalysts 906 disposed along the line 912 may form a ring-shaped sub-catalyst. For example, the exhaust gas treatment device 902 may include one or two ring-shaped sub-catalysts disposed along the line 912. The exhaust gas treatment device may further include a ring-shaped catalyst disposed along line 914. In this manner, the exhaust gas treatment device 902 shown in FIG. 9 may include four, five, six, or seven sub-catalysts splitting the exhaust gas flow 905 into a corresponding number of gas flows.

Thus, an exhaust gas treatment device may include four, five, six, or seven sub-catalysts which divide the exhaust flow through the exhaust gas treatment device into four, five, six, or seven flow paths, respectively. In this way, a catalyst surface area through which exhaust gas flows may be increased and a length along which each portion of exhaust gas flow may be decreased, thereby reducing a pressure drop on the system

FIG. 10 shows another example embodiment of an exhaust gas treatment system 1000 with an exhaust gas treatment device 1002 with a split flow path. An exhaust gas flow 1005 from an engine, such as engine 202 described above with reference to FIG. 2, enters the exhaust gas treatment device 1002 via primary flow passage 1004 (e.g., entry flow path). Once inside the exhaust gas treatment device 1002, the primary flow passage 1004 is divided into six, seven, eight, nine, ten, or eleven gas flows along a corresponding number of flow paths, as will be described below. In an embodiment, each of the sub-catalysts 1006 may be a different exhaust gas treatment device, for example.

In the example embodiment of FIG. 10, the exhaust gas treatment device 1002 includes eleven sub-catalysts 1006 disposed therein and arranged in a tiered configuration along the length of the exhaust gas treatment device 1002. Six of the sub-catalysts are positioned along the same line 1012, four of the sub-catalysts are positioned downstream along another line 1014, and an eleventh sub-catalyst is positioned furthest downstream along line 1016. Each of the sub-catalysts 1006 extends only partially across a diameter of the exhaust gas treatment device 1002 such that each sub-catalyst receives a different portion of the exhaust gas flow 1005.

In some embodiments, each of the sub-catalysts 1006 is substantially the same. For example, the sub-catalysts 1006 may be formed of the same material (e.g., substrate, catalyst, washcoat, or the like) and have the same size and structure (e.g., channel diameter and spacing). In other embodiments, each of the sub-catalysts may be different. In one example, one or more of the sub-catalysts may have a different shape and/or cross-sectional area. In the example of FIG. 10, all but one of the sub-catalysts have the same shape, for example. Alternatively or additionally, the sub-catalysts may have different substrates and/or coatings such that one of the sub-catalysts is more effective at a relatively high temperature and the other sub-catalyst is more effective at a relatively low temperature, for example.

Further, FIG. 10 shows an example embodiment in which each of the sub-catalysts 1006 forms a flow path 1008 along which a different portion of exhaust gas from the primary flow passage 1004 flows. The exhaust gas treatment device 1002 further includes a plurality of flow dividers 1010 positioned between the sub-catalysts such that exhaust gas that exits one sub-catalyst does not enter any of the other sub-catalysts. The dividers 1010 may be formed of any suitable material such as stainless steel, for example. In some embodiments, one or both sides of one or more of the dividers 1010 may be coated with a catalytic material to further facilitate emissions reduction. The dividers 1010 may be attached or otherwise secured in any suitable manner.

In some examples, two of the sub-catalysts 1006 disposed along the line 1012 may form a ring-shaped sub-catalyst. For example, the exhaust gas treatment device 902 may include one, two, or three ring-shaped sub-catalysts disposed along the line 1012. The exhaust gas treatment device may further include one or two ring-shaped catalysts disposed along line 1014. In this manner, the exhaust gas treatment device 1002 depicted in FIG. 10 may include six, seven, eight, nine, ten, or eleven sub-catalysts splitting the exhaust gas flow 1005 into a corresponding number of gas flows.

Thus, an exhaust gas treatment device may include six, seven, eight, nine, ten, or eleven sub-catalysts which divide the exhaust flow through the exhaust gas treatment device into six, seven, eight, nine, ten, or eleven flow paths, respectively. In this way, a catalyst surface area through which exhaust gas flows may be increased and a length along which each portion of exhaust gas flow may be decreased, thereby reducing a pressure drop on the system

The illustrated embodiments in FIGS. 5-10 are provided as examples, but are not meant to be limiting in any way. To the contrary, the illustrated embodiments are intended to demonstrate general concepts, which may be applied to a variety of different applications without departing from the scope of this disclosure. For example, the exhaust gas treatment device may include any suitable number of sub-catalysts splitting the exhaust gas flow from the engine into a corresponding number of flow paths. Further, the sub-catalysts may be positioned in the exhaust gas treatment device in any suitable configuration. A size and shape of each sub-catalyst may vary based on the configuration of the sub-catalysts within the exhaust gas treatment device, for example.

FIG. 11 shows a flow chart illustrating an example embodiment of a method 1100 for controlling the flow of exhaust gas through an exhaust gas treatment device, such as exhaust gas treatment device 502 described above with reference to FIG. 5. Specifically, method 1100 determines operating conditions and adjusts flow through the exhaust gas treatment device accordingly.

At 1102 of method 1100, operating conditions of the engine and/or exhaust gas treatment system are determined. The operating conditions may include exhaust gas temperature, engine load, sub-catalyst temperature, etc.

Once the operating conditions are determined, method 1100 proceeds to 1104 where it is determined if the exhaust gas temperature is greater than a threshold temperature. For example, exhaust gas temperature may be measured by an exhaust gas temperature sensor positioned in the exhaust passage. The threshold temperature may be based on a warm-up condition of the engine or based on engine load, for example. As an example, under low engine loads, the exhaust gas may have relatively low temperature as compared to the exhaust gas temperature under high loads.

If it is determined that the exhaust gas temperature is less than the threshold temperature, method 1100 continues to 1106 where the valve, such as valve 514 described above with reference to FIG. 5, is closed to direct the exhaust gas flow along the second flow path through the second sub-catalyst, and to substantially reduce flow along the first flow path through the first sub-catalyst.

At 1108 of method 1100, it is determined if the exhaust gas temperature is above a threshold temperature. In some examples, the threshold temperature may be the same threshold temperature as described above at 1104 of method 1100. In other examples, the threshold temperature may be a different threshold temperature than that described above at 1104 of method 1100.

If it is determined that the threshold temperature is not greater than the threshold temperature, method 1100 returns to 1108 and the valve remains in the closed position. On the other hand, if it is determined that the exhaust gas temperature is greater than the threshold temperature at 1108 or if it determined that the exhaust gas temperature is greater than the threshold temperature at 1104, method 1100 moves to 1110.

At 1100 of method 1100, the valve is opened such that a first portion of the exhaust gas flow along the primary exhaust passage is directed along a first flow path through the first sub-catalyst and a second portion of the exhaust gas flow is directed along the second flow path through the second sub-catalyst such that it bypasses the first sub-catalyst.

In other embodiments, control of the valve may be based on engine load. For example, during low load conditions, the valve may be closed such that flow through the first sub-catalyst is substantially reduced and a substantial portion of the exhaust gas flowing through the primary flow passage flows along the second flow path and through the second sub-catalyst. In this manner, the exhaust gas treatment device may operate with a higher efficiency, for example. Further, by using a valve to control flow through the exhaust gas treatment device, degradation of the exhaust gas treatment device may be reduced.

In another embodiment, control of the valve may be based on sub-catalyst temperature. For example, a threshold temperature may be a light-off temperature of the first sub-catalyst or the second sub-catalyst. When a temperature of the first sub-catalyst is less than the threshold temperature, the valve may be closed to substantially reduce flow through the first sub-catalyst. In this way, light-off time of one or both of the sub-catalysts may be reduced, for example.

Thus, a valve positioned upstream of an exhaust gas treatment device with a plurality of sub-catalysts may be adjusted to control exhaust gas flow along flow paths corresponding to each of the sub-catalysts. As such, efficiency of the exhaust gas treatment device may be increased and degradation may be reduced.

The method 1100 is described for an example embodiment in which the exhaust gas treatment system includes an exhaust gas treatment device which has two sub-catalysts, such as the example embodiment depicted in FIG. 5. It should be understood, however, that the method may be applied to an exhaust gas treatment system that includes any suitable number of sub-catalysts, such as the example embodiments depicted in FIGS. 6-10, for example.

As explained above, the terms “high temperature” and “low temperature” are relative, meaning that “high” temperature is a pressure higher than a “low” temperature. Conversely, a “low” temperature is a pressure lower than a “high” temperature.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

1. An exhaust gas treatment system, comprising:
a primary flow passage through which exhaust gas flows to an exhaust gas treatment device;
a first sub-catalyst partially disposed in the primary flow passage splitting the exhaust gas into a first gas flow and a bypass flow; and
a second sub-catalyst disposed downstream of the first catalyst in the bypass flow forming a second gas flow, where the second gas flow is different from the first gas flow.

2. The exhaust gas treatment system of claim 1, wherein the first sub-catalyst extends partially across a diameter of the exhaust gas treatment device, and the second sub-catalyst extends partially across the diameter of the exhaust gas treatment device, and wherein the second sub-catalyst is downstream of the first sub-catalyst and a flow divider is coupled between the first sub-catalyst and the second sub-catalyst.

3. The exhaust gas treatment system of claim 1, wherein, along a direction perpendicular to a direction of exhaust gas flow, a cross-sectional area of the first sub-catalyst is substantially the same as a cross-sectional area of the second sub-catalyst.

4. The exhaust gas treatment system of claim 1, wherein the exhaust gas treatment device is upstream of a turbine of a turbocharger.

5. The exhaust gas treatment system of claim 1, further comprising a third sub-catalyst disposed in the bypass flow forming a third gas flow, where the third gas flow is different from the first gas flow and the second gas flow.

6. The exhaust gas treatment system of claim 5, further comprising a fourth sub-catalyst forming a fourth gas flow and a fifth sub-catalyst forming a fifth gas flow, the sub-catalysts arranged in a tiered configuration.

7. The exhaust gas treatment system of claim 1, wherein the exhaust gas treatment system coupled to an engine of a locomotive, the engine comprising one of a 10 cylinder engine, a 12 cylinder engine, a 14 cylinder engine, or a 16 cylinder engine.

8. The exhaust gas treatment system of claim 1, wherein the first sub-catalyst and the second sub-catalyst are substantially the same.

9. The exhaust gas treatment system of claim 1, wherein the first sub-catalyst and the second sub-catalyst are different.

10. The exhaust gas treatment system of claim 1, wherein the exhaust gas treatment device is positioned downstream of a valve configured to substantially reduce flow to the first sub-catalyst when in a closed position.

11. A method for an exhaust gas treatment system coupled to an engine, the exhaust gas treatment system including an exhaust gas treatment device with a plurality of sub-catalysts, comprising:
directing an exhaust gas flow from the engine to the exhaust gas treatment device along a primary flow passage;
splitting the exhaust gas flow into a first flow path by directing a first portion of exhaust gas through a first sub-catalyst partially disposed in the primary flow passage of the exhaust gas treatment device; and
directing a different, second portion of exhaust gas along a second flow path, bypassing the first sub-catalyst, where the second flow path directs the second portion of exhaust gas through a second sub-catalyst disposed in the primary flow passage.

12. The method of claim 11, further comprising, based on an operating condition, adjusting a valve positioned upstream of the exhaust gas treatment device to substantially reduce flow to the first sub-catalyst, and wherein the valve is a gate valve.

13. The method of claim 12, wherein the operating condition includes at least one of low engine load, exhaust gas temperature below a threshold temperature, and a temperature of the first sub-catalyst or the second sub-catalyst below a threshold temperature.

14. The method of claim 11, wherein the engine is positioned in a rail vehicle, a marine vessel, or an off-highway vehicle.

15. The method of claim 11, further comprising, directing a different, third portion of exhaust gas along a third flow path, bypassing the first sub-catalyst and the second sub-catalyst, where the third flow path directs the third portion of exhaust gas through a third sub-catalyst disposed in the primary flow passage

16. A system comprising:
an engine cab defined by a roof assembly and side walls;
an engine positioned in the engine cab such that a longitudinal axis of the engine is aligned in parallel with a length of the engine cab; and
an exhaust gas treatment system mounted on the engine within a space defined by a top surface of an exhaust manifold of the engine, the roof assembly, and the side walls of the engine cab such that a longitudinal axis of the exhaust gas treatment system is aligned in parallel with the longitudinal axis of the engine, the exhaust gas treatment system including an exhaust gas treatment device with a primary flow passage and a plurality of sub-catalysts, where at least one sub-catalyst is partially disposed in the primary flow passage where a first flow path passes exhaust gas through the first sub-catalyst and a second flow path bypasses the first sub-catalyst.

17. The system of claim 16, further comprising a turbocharger with a turbine and a compressor, the turbine positioned downstream of the exhaust gas treatment device.

18. The system of claim 16, further comprising a controller in communication with one or more temperature sensors positioned in the exhaust gas treatment device and configured to control a valve to adjust flow along one or more of the flow paths based on communication from the temperature sensors.

19. An exhaust gas treatment device, comprising:
a flow passage;
a first sub-catalyst disposed in the flow passage and located at a first location along the flow passage, wherein the first sub-catalyst partially but not entirely fills a radial extent of the flow passage at the first location, and wherein a portion of the radial extent at the first location that is not filled by the first sub-catalyst is unoccupied, such that exhaust gas can flow unfettered around the first sub-catalyst; and
a second sub-catalyst disposed in the flow passage and located at a downstream, second location along the flow passage, wherein the second sub-catalyst partially but not entirely fills a radial extent of the flow passage at the second location, and wherein a portion of the radial extent at the second location that is not filled by the second sub-catalyst is unoccupied, such that exhaust gas can flow unfettered around the second sub-catalyst.

20. The exhaust gas treatment device of claim 19, further comprising a flow divider interconnecting the first sub-catalyst and the second sub-catalyst, wherein the flow divider interconnects distal edges of the first sub-catalyst and the second sub-catalyst that are not abutting the flow passage, the flow divider channeling exhaust passing through the unoccupied radial extent at the first location to an input of the second sub-catalyst, and channeling exhaust exiting the first sub-catalyst to the unoccupied radial extent at the second location.
